(19) United States
(12) Patent Application Publication
(10) Pub. No.: US 2026/0014733 A1
(43) Pub. Date: Jan. 15, 2026

(54) Auxliiary Platform for Wood Board Milling Machine

(71) Applicant: Hangzhou Junting Network Technology Co., Ltd., Zhejiang (CN)

(72) Inventor: Yi YI, Zhejiang (CN)

(73) Assignee: Hangzhou Junting Network Technology Co., Ltd., Zhejiang (CN)

(21) Appl. No.: 19/338,023

(22) Filed: Sep. 24, 2025

(51) Int. Cl. B27C 5/02

(52) U.S. Cl. CPC B27C 5/02

(57) ABSTRACT

The present disclosure relates to an auxiliary platform for a wood board milling machine, comprising a platform body, a drive assembly, a dust collection assembly and a positioning assembly. Through the vertical arrangement of horizontal and vertical guide rails and the sliding fit of engagement protrusions/grooves, precise sliding positioning of the platform in the horizontal two-dimensional direction is achieved; the height-adjusting screws and a plurality of optical shafts collaboratively ensure stable lifting; the hollow pipeline, dust suction pipe, and protective curtain work together to efficiently remove milling debris, significantly improving milling accuracy, stability, and the cleanliness of the processing environment.

### TECHNICAL FIELD

The present disclosure relates to the technical field of wood processing equipment, particularly to an auxiliary platform for a wood board milling machine.

### BACKGROUND

In the field of wood processing, board milling is a common and critical process. As the core component carrying the milling drive assembly, the auxiliary platform needs to flexibly adjust the working position of the drive assembly in the horizontal direction to accommodate the processing requirements of boards of different sizes and meet the precision machining demands for various milling areas. However, existing auxiliary platforms in the prior art have many shortcomings that urgently need addressing: On one hand, most auxiliary platforms rely on manual pushing for position adjustment, completely lacking precise guiding mechanisms, which often leads to deviation or jamming during movement, making it difficult to accurately position the drive assembly to the preset target milling location. This directly reduces the milling precision and results in poor consistency in processing batches of boards, severely affecting product quality stability. On the other hand, even if some auxiliary platforms are equipped with guiding devices, these devices mostly only provide single-direction rail guidance, failing to meet the flexible and precise displacement needs in two-dimensional horizontal (lateral and longitudinal) movements. When cross-region milling range adjustments are required during processing, the operational procedures become highly cumbersome, and repeated adjustments tend to accumulate positioning errors, further diminishing the precision and efficiency of milling operations.

### SUMMARY

The present disclosure provides an auxiliary platform for a wood board milling machine to address the issues raised in the background art.

To achieve the above object, the present disclosure adopts the following technical solutions:

An auxiliary platform for a wood board milling machine comprises a platform body configured to carry a drive assembly; and a positioning assembly supporting the platform body, comprising: a horizontal guide rail assembly, comprising at least one first rail extending along a first horizontal direction; and a vertical guide rail assembly, comprising at least one second rail extending along a second horizontal direction, wherein the second horizontal direction is perpendicular to the first horizontal direction. The platform body is slidably connected to the first rail through a first guiding structure, and the horizontal guide rail assembly is slidably connected to the second rail through a second guiding structure. Both the first guiding structure and the second guiding structure comprise an engagement protrusion and an engagement groove that are mutually engaged, and the engagement protrusion is embedded in the engagement groove to form sliding fit for restricting displacement of connected components in directions perpendicular to movement while providing sliding guidance.

An auxiliary platform for a wood board milling machine comprises a platform body configured to carry a drive assembly, the platform body comprising an internally hollow pipeline, the pipeline comprising at least one set of connecting holes; and a dust collection assembly, comprising at least one dust suction pipe, one end of the dust suction pipe being connected to the connecting holes of the pipeline, and the other end being configured to connect to an external negative pressure generator; and a positioning assembly supporting the platform body, comprising: a horizontal guide rail assembly, comprising at least one first rail extending along a first horizontal direction; and a vertical guide rail assembly, comprising at least one second rail extending along a second horizontal direction, wherein the second horizontal direction is perpendicular to the first horizontal direction. The platform body is slidably connected to the first rail through a first guiding structure, and the horizontal guide rail assembly is slidably connected to the second rail through a second guiding structure. Both the first guiding structure and the second guiding structure comprise an engagement protrusion and an engagement groove that are mutually engaged, and the engagement protrusion is embedded in the engagement groove to form sliding fit for restricting displacement of connected components in a direction perpendicular to a movement direction while providing sliding guidance.

An auxiliary platform for a wood board milling machine comprises a platform body configured to carry a drive assembly, the platform body comprising a connection frame and a base plate arranged below the connection frame; and a height adjustment mechanism integrated into the platform body for adjusting a height of the base plate relative to the connection frame, thereby regulating a milling height of the drive assembly, wherein the height adjustment mechanism comprises: an adjusting screw, with the connection frame penetrating therethrough, and a bottom end in running fit the base plate; a locking key sleeved onto the adjusting screw for locking or releasing the adjusting screw; and a positioning assembly supporting the platform body, comprising: a horizontal guide rail assembly, comprising at least one first rail extending along a first horizontal direction; and a vertical guide rail assembly, comprising at least one second rail extending along a second horizontal direction, wherein the second horizontal direction is perpendicular to the first horizontal direction. The platform body is slidably connected to the first rail through a first guiding structure, and the horizontal guide rail assembly is slidably connected to the second rail through a second guiding structure. Both the first and second guiding structures comprise an engagement protrusion and an engagement groove that are mutually engaged, and the engagement protrusion is embedded in the engagement groove to form sliding fit for restricting displacement of connected components in a direction perpendicular to a movement direction while providing sliding guidance.

The beneficial effects of the present disclosure compared to the prior art are:

Through the vertical adaptation structure of the horizontal guide rail assembly and vertical guide rail assembly in the positioning assembly, as well as the sliding fit design between the first engagement protrusion and first engagement groove and the second engagement protrusion and second engagement groove, this solution not only addresses the shortcomings of existing platforms lacking precise guidance and being limited to unidirectional displacement but also avoids the stuttering issues caused by rigid contact, enabling the platform body and drive assembly to move smoothly along the two-dimensional horizontal plane, significantly improving milling position accuracy. The coordinated structure of the height-adjusting screw and six symmetrical optical shafts in the platform body allows flexible adaptation to milling height requirements for wood boards of varying thicknesses through the screw's threaded transmission while restricting tilting deflection of the base plate through the linear guidance of the optical shafts, ensuring lifting stability. Simultaneously, the plurality of concentric through-hole layouts of the connection assembly enhance compatibility with drive assemblies of different specifications. The collaborative suction structure of the dust suction pipe and pipeline dust suction chamber in the dust collection assembly, combined with the enclosed layout of the protective curtain along the edge of the base plate, enables comprehensive cleaning of milling debris through negative pressure suction while reducing dust dispersion and preventing debris accumulation from affecting equipment operation. The columnar vertical fixation structures of the handle assemblies on both sides of the platform body allow operators to conveniently grip and push the platform along the rails, reducing the operational difficulty of position adjustment and enabling efficient adjustment of the drive assembly's working position, thereby improving the precision, efficiency, and practicality of wood board milling operations across a plurality of dimensions.

### BRIEF DESCRIPTION OF DRAWINGS

The drawings, which form part of this application, are provided to further illustrate the present disclosure. The illustrative embodiments and the descriptions thereof are intended to explain the present disclosure and do not constitute undue limitations. In the drawings:

FIG. 1 is a perspective schematic of an embodiment provided by the present disclosure;

FIG. 2 is a structural schematic of the main platform, dust collection assembly, and drive assembly in the embodiment of FIG. 1;

FIG. 3 is a perspective schematic of the drive assembly in the embodiment shown in FIG. 1;

FIG. 4 is a perspective schematic of the fixing plate in the embodiment shown in FIG. 1;

FIG. 5 is another perspective schematic of the embodiment shown in FIG. 2;

FIG. 6 is another perspective schematic of the embodiment shown in FIG. 2;

FIG. 7 is a schematic of the main platform in the embodiment shown in FIG. 1;

FIG. 8 is another schematic of the embodiment shown in FIG. 1;

FIG. 9 is a partial enlarged schematic of section A in the embodiment shown in FIG. 8;

FIG. 10 is a partial enlarged schematic of section B in the embodiment shown in FIG. 8;

FIG. 11 is an exploded schematic of the first bracket and first rail in the embodiment shown in FIG. 8;

FIG. 12 is an exploded schematic of the second bracket and second rail in the embodiment shown in FIG. 8;

Reference signs: Platform Body (100); Accommodating Cavity (110); Connection Assembly (120); Pipeline (130); First Bracket (140); Handle Assembly (150); Connection Frame (101); Base Plate (102); Adjusting Screw (103); Locking Key (104); Adjusting Knob (105); Optical Shaft (106); Protective Curtain (107); Fixing Plate (121); Fastener (122); Through Hole (1211); Connecting Hole (131); Dust Suction Chamber (132); First Engagement Groove (141); Dust Collection Assembly (200); Dust Suction Pipe (210); Opening (211); Positioning Assembly (300); Horizontal Guide Rail Assembly (310); Vertical Guide Rail Assembly (320); First Rail (311); Second Bracket (312); Second Rail (321); First Engagement Protrusion (3111); Second Engagement Groove (3121); Second Engagement Protrusion (3211); Drive Assembly (400); Drive Motor (410); Milling Blade (420).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings

In the present disclosure, addressing technical shortcomings of existing auxiliary platforms for wood board milling machines—such as the lack of precise guidance for position adjustment, susceptibility to deviation and jamming, the inability of single-direction guide rails to meet flexible horizontal two-dimensional displacement, and insufficient compatibility and stability of connection structures—an auxiliary platform for a wood board milling machines is provided. This auxiliary platform features a collaborative structure including a platform body 100, a dust collection assembly 200, a positioning assembly 300, and a drive assembly 400. The platform body 100 ensures stable support for the drive assembly 400 and flexible adjustment of milling height, while the dust collection assembly 200 achieves comprehensive and efficient cleaning of debris in the milling area. The positioning assembly 300, through the vertical alignment of a horizontal guide rail assembly 310 and a vertical guide rail assembly 320, enables precise horizontal two-dimensional displacement of the platform body 100 and drive assembly 400, along with stable positioning of the working location. The specific implementation of this auxiliary platform will be described in detail below with reference to the accompanying drawings.

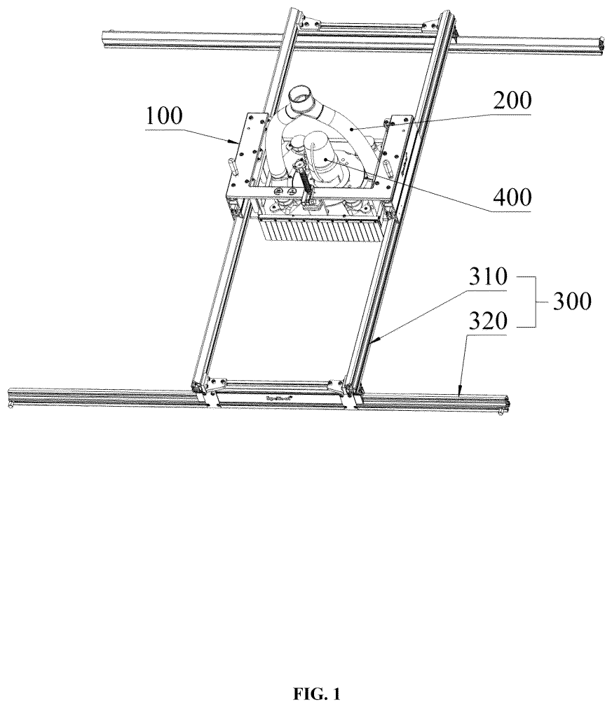

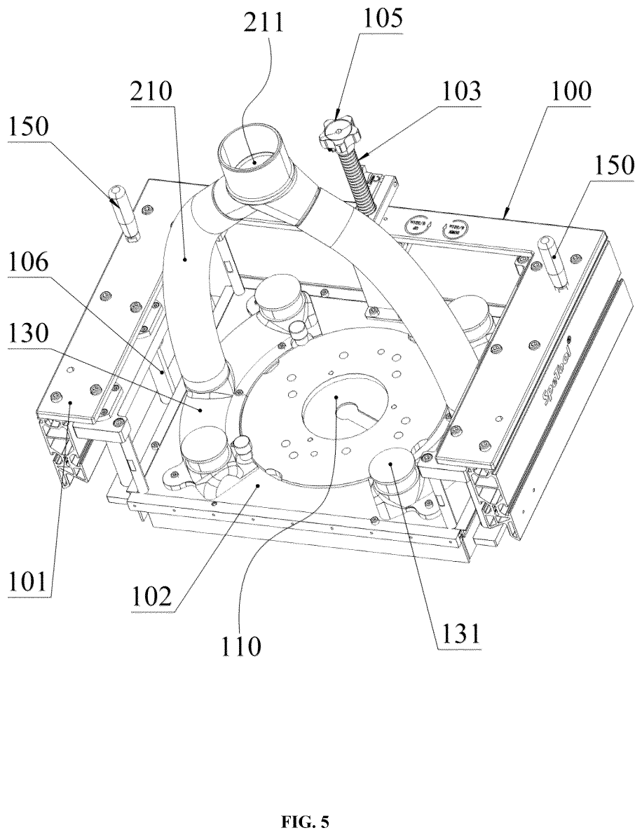

As shown in FIGS. 1, 2, and 3, the present disclosure provides an auxiliary platform for a wood board milling machines, which includes a platform body 100, a dust collection assembly 200, a positioning assembly 300, and a drive assembly 400. The platform body 100 is a square frame structure with a central recess forming an accommodating cavity 110 for housing the drive assembly 400. The drive assembly 400 is the core execution device for wood board milling, including a drive motor 410 and a milling blade 420. The drive motor 410 serves as the power source and is securely fixed within the accommodating cavity 110 through a connection assembly 120 on the base plate of the platform body 100 (see FIG. 5). The connection area is embedded with elastic damping pads to effectively absorb vibrations during motor operation, preventing resonance from affecting wood processing accuracy. The drive motor 410 transmits rotational power to the milling blade 420 through a transmission mechanism to ensure stable operation. The milling blade 420 is detachable, made of hard alloy material, and features a finely ground edge to guarantee milling smoothness. Its detachable design facilitates easy cleaning and replacement of the blade and transmission mechanism components. After the drive assembly 400 is installed on the platform body 100, the milling blade 420 extends to the lower part of the platform body 100 and contacts the wood board surface during operation for processing and polishing of the wood.

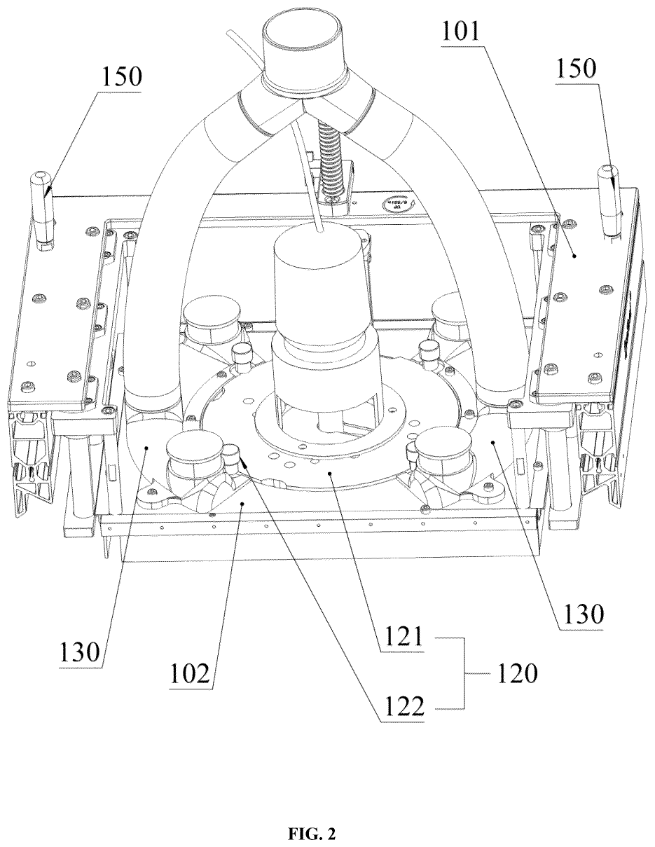

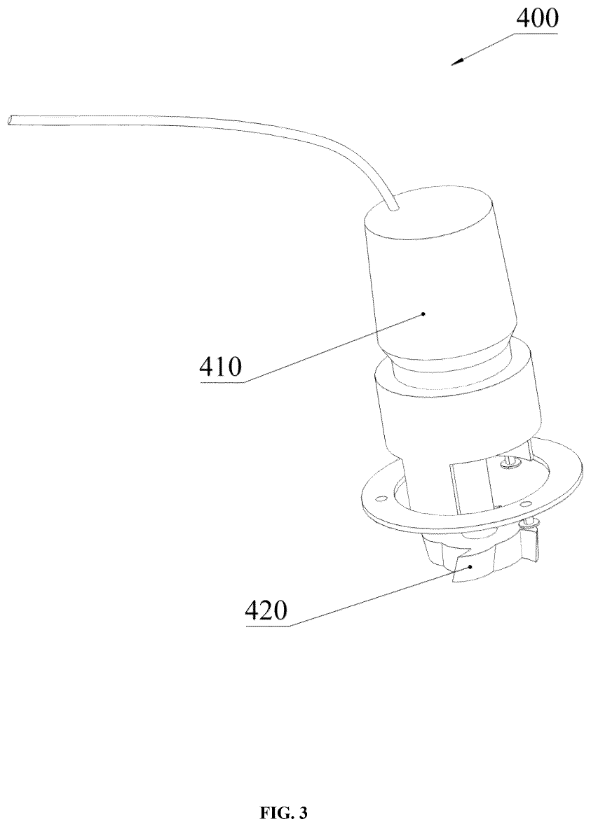

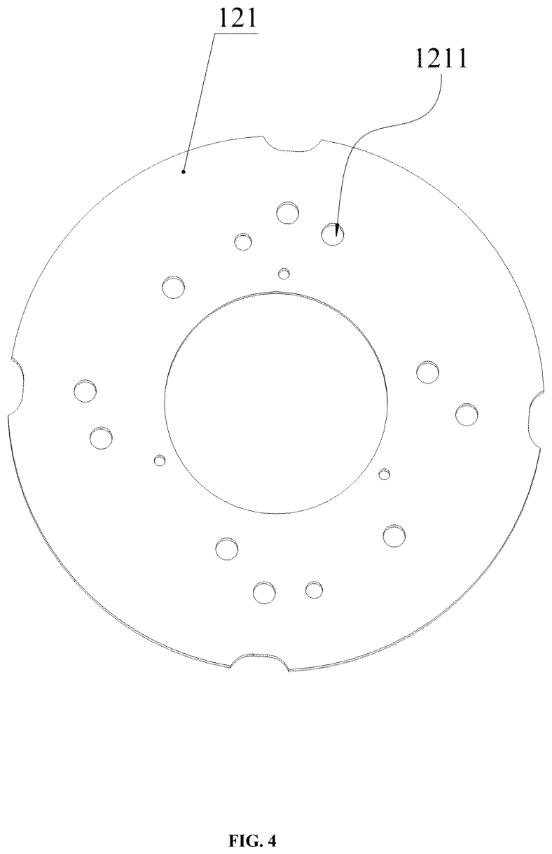

Specifically, referring to FIGS. 2 and 4, the connection assembly 120 includes a fixing plate 121 and a plurality of fasteners 122 arranged around the fixing plate 121. In the preferred embodiment of the present disclosure, the fasteners 122 are preferably bolt structures, and the fixing plate 121 is preferably a circular connecting plate. The surface of the fixing plate 121 is provided with a plurality of sets of through holes 1211, which are concentrically distributed in a plurality of rings along the radial direction of the fixing plate 121. The spacing of the holes in each ring is set according to the conventional size gradient of the drive assembly 400 (see FIG. 3), allowing compatibility with drive assemblies 400 of different bottom mounting hole specifications. During installation, the fasteners 122 are evenly distributed along the edge of the fixing plate 121. The threaded part of each fastener passes through the corresponding mounting hole of the platform body 100, and by tightening the nut, the head of the fastener presses the periphery of the fixing plate 121 firmly against the bottom of the accommodating cavity 110 of the platform body 100. This achieves a stable assembly of the drive assembly 400 and the platform body 100, ensuring both connection strength and improved compatibility with drive assemblies 400 of different sizes through the layout of a plurality of sets of through holes 1211.

As shown in FIGS. 2 and 5, the platform body 100 includes a set of oppositely arranged pipelines 130, which are constructed as hollow arched protrusions. The surface of each pipeline 130 is spaced with three corresponding connecting holes 131 along the arc extension direction. The hollow interior of the pipeline 130 forms a dust suction chamber 132, which is connected to the bottom surface of the platform body 100. The dust collection assembly 200 is constructed as a set of dust suction pipes 210, which includes two pipes. One end of each pipe is detachably fixed to the connecting holes 131 of the pipeline 130 through threaded connections or strap fastening, while the other ends converge into a single opening 211. This opening 211 is used to connect to an external negative pressure generator (not shown), which may include any form of dust collector or vacuum pump. During operation, the dust suction chamber 132 directly adheres to the wood board surface, forming a collaborative cleaning structure with the two dust suction pipes 210: the external negative pressure generator creates a vacuum, generating a suction field within the dust suction pipes 210 and the dust suction chamber 132. The dust suction chamber 132 directly adheres to the wood board surface, and wood chips, dust, and other debris on the board are drawn into the dust suction chamber 132 under negative pressure. All debris is ultimately transported outside the platform body 100 through the pipeline 130 and the dust suction pipes 210, achieving comprehensive cleaning of the milling area and preventing debris accumulation from affecting machining accuracy and equipment stability.

As shown in FIGS. 5, 6, and 7, the platform body 100 includes a connection frame 101, a base plate 102, an adjusting screw 103, and a locking key 104. The connection frame 101 is a rectangular frame, and the base plate 102 is arranged parallel below the connection frame 101 to carry core components such as the drive assembly 400 (see FIG. 1). The adjusting screw 103 and the locking key 104 together form the height adjustment mechanism of the platform body 100 in the present disclosure. This mechanism is integrated into the platform body and is used to adjust the height of the base plate 102 relative to the connection frame 101, thereby regulating the milling height of the drive assembly 400. Specifically, the base plate 102 and the connection frame 101 are fixedly connected through the adjusting screw 103, allowing the base plate 102 to move vertically along the axial direction of the adjusting screw 103 to adjust the milling height, accommodating wood boards of varying thicknesses. The bottom end of the adjusting screw 103 is in running fit with the base plate 102, the middle section is threaded and passes through a threaded hole in the connection frame 101, and the top end extends beyond the connection frame 101 and is equipped with an adjusting knob 105. The locking key 104 has a clamp-style structure and is sleeved over the middle section of the adjusting screw 103. During adjustment, the locking key 104 is loosened by rotating it in the first direction (e.g., counterclockwise) to release the circumferential lock on the adjusting screw 103. The adjusting knob 105 at the top of the adjusting screw 103 is then turned to raise or lower the base plate 102 relative to the connection frame 101 through threaded transmission, achieving milling height adjustment. After adjustment, the locking key 104 is tightened by rotating it in the second direction (e.g., clockwise) to engage with the threads of the adjusting screw 103, locking the screw 103 in place and ensuring the platform body 100 remains stable during operation, preventing displacement that could affect machining accuracy.

To further ensure the stability and balance of the base plate 102 during vertical movement, the platform body 100 is symmetrically equipped with a plurality of optical shafts 106 between the connection frame 101 and the base plate 102—preferably six in this disclosure. Both ends of each optical shaft 106 are vertically and fixedly connected to the connection frame 101 and the base plate 102, respectively, and the optical shafts 106 are arranged parallel to the height adjustment screw 103. When the base plate 102 moves vertically along the adjusting screw 103, the optical shafts 106, leveraging their linear guiding properties, restrict the base plate 102 to purely vertical translation, preventing tilting or deflection. Meanwhile, the symmetrical layout of the six optical shafts 106 evenly distributes the gravitational load of the base plate 102 and the components above it. Combined with the transmission of the adjusting screw 103, this ensures the height adjustment process of the entire platform body 100 is both smooth and precise, further enhancing adaptability and machining stability for milling wood boards of different thicknesses.

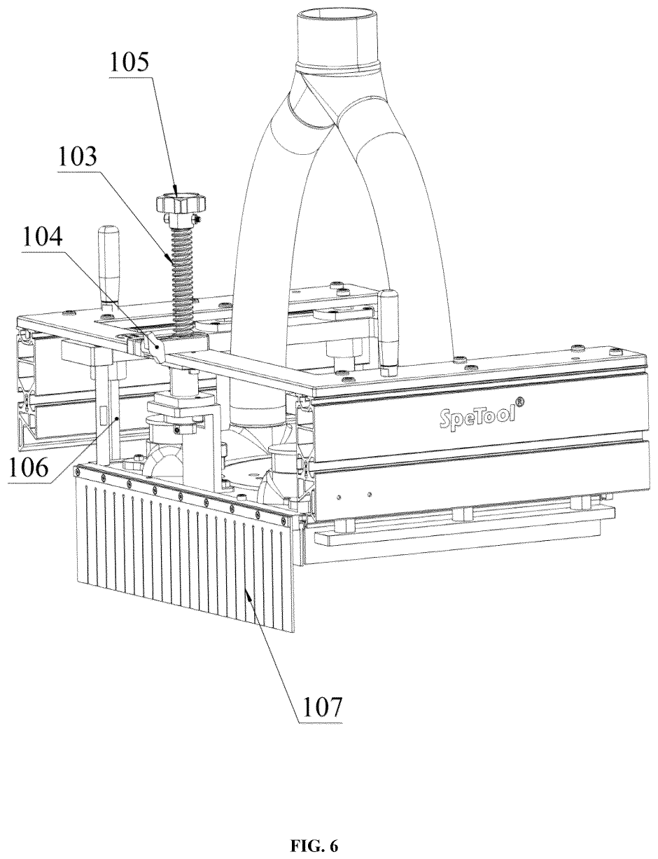

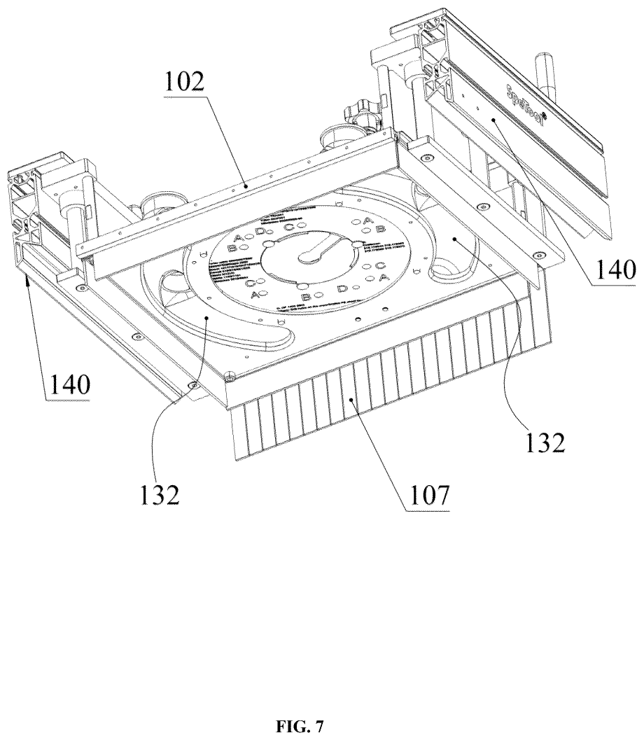

Referring to FIGS. 6 and 7, the base plate 102 of the platform body 100 is equipped with a protective curtain 107, which consists of a plurality of parallel, elastically deformable plate-shaped components distributed along the edge of the working area of the base plate 102. During operation, after the platform body 100 is adjusted to the target milling height, the protective curtain 107 can closely adhere to the surface of the wood board to be processed due to its flexibility or gravity: on one hand, it encloses a relatively closed milling space, working in synergy with the dust collection assembly 200 (see FIG. 1) to reduce the outward spread of wood chips and dust, improving dust collection efficiency; on the other hand, it also mitigates the leakage of milling noise, optimizing the working environment.

In other embodiments (not shown), to further enhance the height adjustment precision of the base plate 102 relative to the connection frame 101 and facilitate rapid on-site reset, the height adjustment mechanism incorporates a multi-stage fine-tuning bolt combination and a scale indicator mechanism. The multi-stage fine-tuning bolts include a main screw for coarse adjustment and a differential screw or gear reduction mechanism for fine-tuning. The pitch of the differential screw or the gear ratio is set to produce small displacements (e.g., micrometer or tens of micrometers scale) per fine-tuning rotation, with the fine-tuning component coaxially arranged with the main screw to ensure concentric transmission. The scale indicator mechanism includes a dial or linear scale markings coaxial with the screw, as well as an indicator window or vernier, to visually display the current height position and facilitate quick reset to a preset height. With this combination, high-resolution height positioning can be achieved while maintaining a large adjustment range, thereby improving positioning accuracy during milling and the surface flatness of the milled wood board.

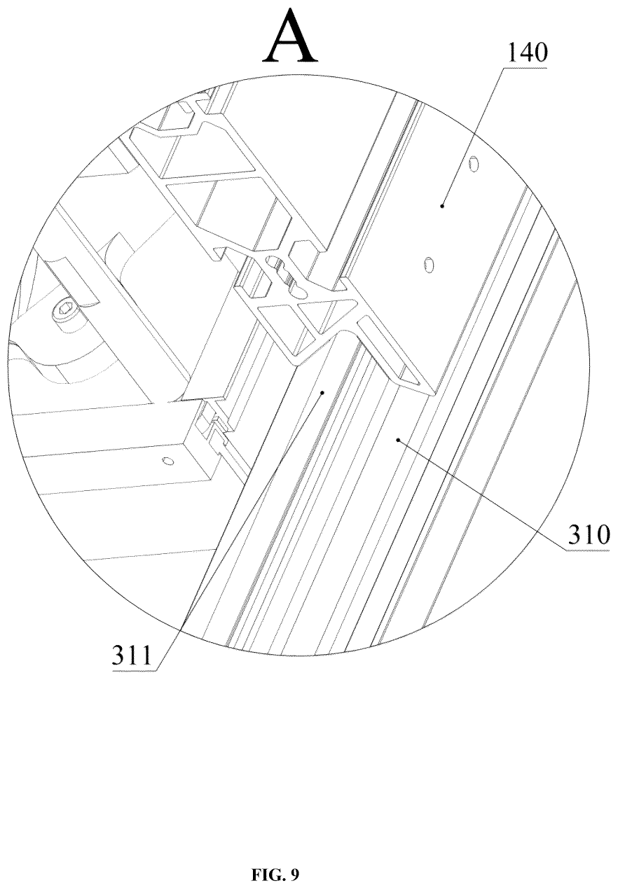

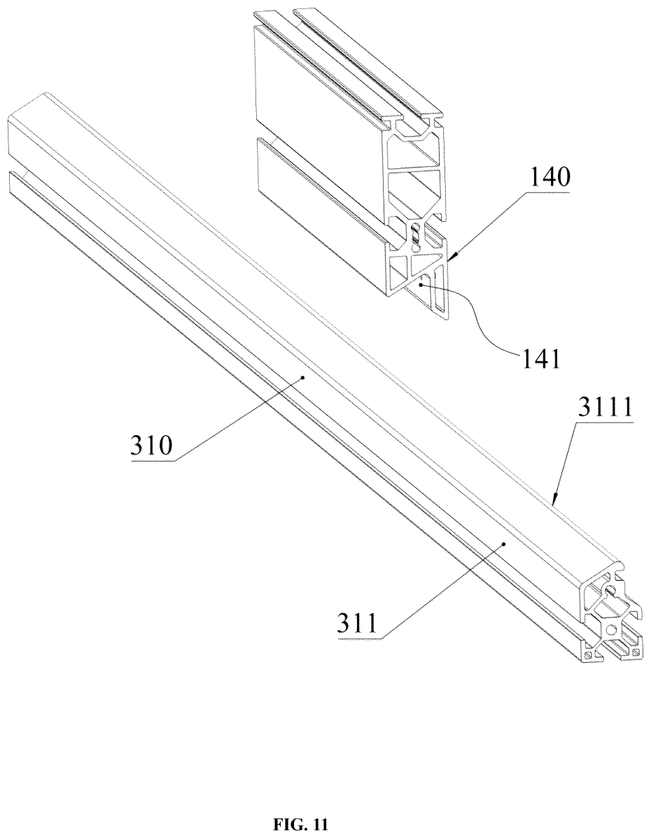

Please also refer to FIGS. 1, 8, 9, and 11. The positioning assembly 300 includes a horizontal guide rail assembly 310 and a vertical guide rail assembly 320. The platform body 100 is slidably connected and precisely guided with the horizontal guide rail assembly 310 through a first guiding structure. Similarly, the horizontal guide rail assembly 310 and the vertical guide rail assembly 320 are slidably connected and precisely guided through a second guiding structure, ensuring accurate positioning and guidance for the working positions of the platform body 100 and the drive assembly 400. Specifically, the horizontal guide rail assembly 310 consists of two parallel first rails 311, providing movement guidance for the platform body 100 along a first horizontal direction. The vertical guide rail assembly 320 includes two second rails 321 assembled perpendicular to the horizontal guide rail assembly, supporting the platform body 100 and the horizontal guide rail assembly 310 for displacement along a second horizontal direction perpendicular to the first. Here, the first and second horizontal directions refer to two mutually perpendicular directions within the same plane. The first guiding structure is formed by a first bracket 140 on the connection frame 101 of the platform body 100 and corresponding features on the first rail 311 of the horizontal guide rail assembly 310. The first bracket 140 forms a first engagement groove 141, while the first rail 311 forms a corresponding first engagement protrusion 3111. During installation, the outer surface of the first engagement protrusion 3111 and the inner surface of the first engagement groove 141 are both bonded with wear-resistant, smooth high-molecular-weight polyethylene tape, creating sliding contact surfaces. When the first engagement protrusion 3111 is inserted into the first engagement groove 141, a slidable connection is achieved through the precise adhesion of the tape. This design of the first guiding structure ensures smooth sliding of the platform body 100 along the extension direction of the first rail 311 (first horizontal direction) with minimal friction and wear, thanks to the low friction coefficient and high wear resistance of the polyethylene tape. Additionally, the mutual constraint between the first engagement protrusion 3111 and the walls of the first engagement groove 141 effectively restricts any displacement deviation of the platform body 100 perpendicular to the first horizontal direction, guaranteeing straightness and positioning accuracy of the movement trajectory.

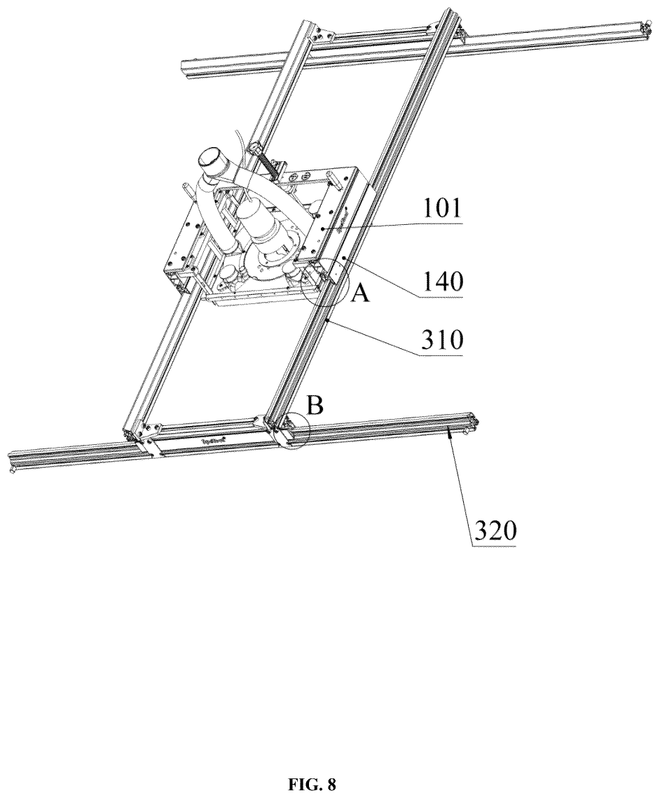

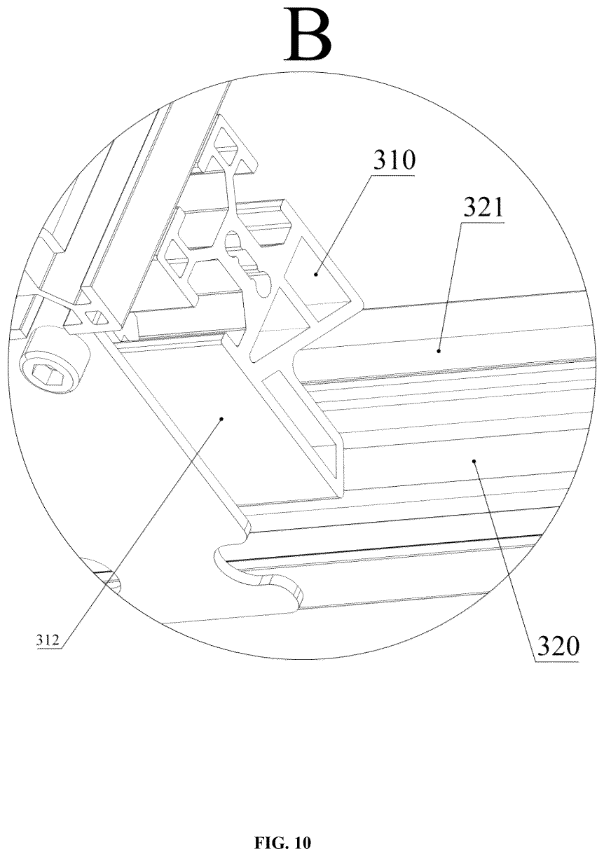

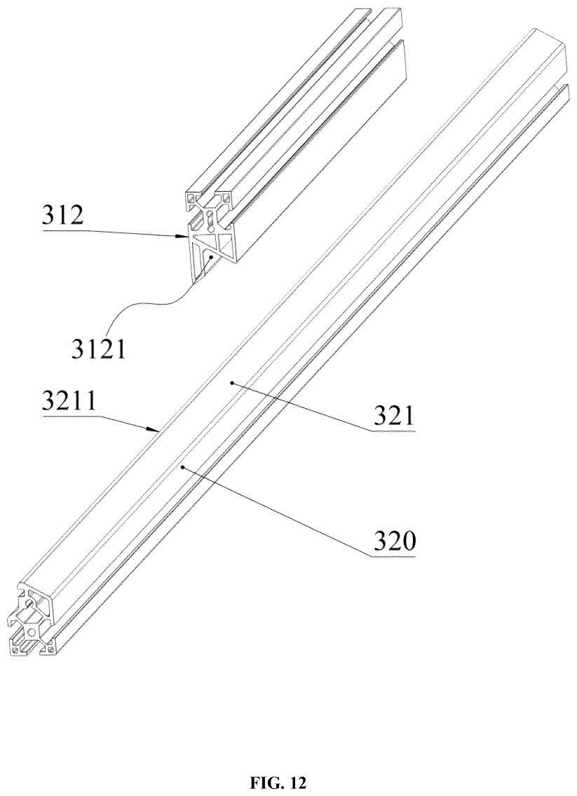

Referring to FIGS. 8, 10, and 12, the second guiding structure is jointly formed by the second bracket 312 mounted on the horizontal guide rail assembly 310 and the corresponding features on the second rail 321 of the vertical guide rail assembly 320. The second bracket 312 forms a second engagement groove 3121, while the second rail 321 correspondingly forms a second engagement protrusion 3211. During installation, the outer side of the second engagement protrusion 3211 and the inner side of the second engagement groove 3121 are both bonded with wear-resistant and smooth high-molecular-weight polyethylene tape, creating sliding pair contact surfaces. After the second engagement protrusion 3211 is inserted into the second engagement groove 3121, a slidable connection is achieved through the precise adhesion of the tape. This second guiding structure leverages the low friction coefficient and high wear resistance of the high-molecular-weight polyethylene tape to ensure that the horizontal guide rail assembly 310 can smoothly drive the platform body 100 along the extension direction of the second rail 321 (the second horizontal direction), reducing sliding resistance and component wear. Simultaneously, the mutual limiting effect between the second engagement protrusion 3211 and the walls of the second engagement groove 3121 effectively restricts displacement deviations of the horizontal guide rail assembly 310 perpendicular to the second horizontal direction, ensuring straightness and positioning accuracy of the movement trajectory. In this disclosure, the first guiding structure and the second guiding structure operate on the same principle, both using high-molecular-weight polyethylene tape as sliding pair contact surfaces, and they are arranged perpendicularly to each other. Together, they achieve precise guidance and stable positioning for the two-dimensional movement of the platform body 100 within the horizontal plane, further enhancing the positional accuracy of the drive assembly 400 during milling operations.

In other embodiments (not shown), to mitigate the adverse effects of vibrations generated by the drive assembly 400 on the positioning and milling accuracy of the platform body 100 during milling, elastic vibration isolators or damping units can be introduced between the platform body 100 and the positioning assembly 300. The elastic vibration isolators or damping units may include elastic pads, damping blocks, shear damping elements, or inflatable airbag-type isolation mounts, either individually or in combination. Among these, the airbag-type isolation mounts can adjust stiffness by varying the inflation level to accommodate different loads, while the shear damping elements suppress high-frequency vibrations through the material's shear energy dissipation mechanism. This vibration isolation structure can be placed at the contact surfaces between the connection frame 101 and the first rail 311, the second bracket 312 and the second rail 321, or as an additional isolation layer between the fixing plate 121 and the drive motor 410, thereby reducing vibration transmission without compromising guiding rigidity. With this design, the amplitude and vibrational energy of the platform during operation are effectively attenuated, significantly improving milling flatness, reducing rail wear, and extending equipment lifespan.

In other embodiments (not shown), to prevent milling debris from entering the cavity of the positioning assembly 300 and causing jamming or reduced accuracy, slidable sealing covers or flexible scrapers can be installed at the horizontal guide rail assembly 310 and the vertical guide rail assembly 320. The sealing covers may adopt a bellows-style protective structure, with one end fixed to the rail and the other end extending or retracting as the platform moves to seal rail gaps. The scrapers can be made of wear-resistant elastic material and fitted along the rail edges to remove granular debris near the rails during platform movement. Both the sealing covers and scrapers can be installed or replaced through detachable connectors or guide slots, facilitating maintenance and cleaning. These protective measures effectively block the accumulation of dust and debris in sliding fit surfaces, reducing operational resistance and maintaining guiding accuracy and long-term stability.

In other embodiments (not shown), the horizontal guide rail assembly 310 and the vertical guide rail assembly 320 can also be configured as telescopic or foldable implementations. Specifically, the rails are composed of a plurality of telescoping sections, which are interconnected through sliding fits or plug-in mechanisms. When extended, each section locks to achieve rigid guidance; when retracted, the sections can be nested or foldably hinged to significantly reduce the occupied volume. Another optional solution is to install a folding hinge at one end of the rail, allowing the rail to flip and adhere to the platform surface in a predetermined direction when folded, secured by a locking mechanism. The materials and connector designs for the telescopic or foldable structure must ensure the required guidance rigidity and repeat positioning accuracy when extended and locked, while remaining portable and transportable in the folded/retracted state. This telescopic/foldable rail solution enables the auxiliary platform to provide high-precision secondary positioning capability on-site while significantly reducing volume during transport or storage, making it suitable for multi-scenario applications.

As shown in FIGS. 1 and 2, the platform body 100 also includes a handle assembly 150, preferably two in number, positioned on either side of the platform body 100. These are columnar structures, vertically fixed to the connection frame 101 of the platform body 100 (see FIG. 5). Operators can conveniently push the platform body 100 along the axial direction of the first rail 311 of the horizontal guide rail assembly 310 or the second rail 321 of the vertical guide rail assembly 320 by gripping the handle assembly 150. This reduces the operational difficulty of manually adjusting the platform position while enabling precise control over the movement process and final docking position of the platform body 100, achieving efficient adjustment of the drive assembly 400's working position.

In summary, the present disclosure achieves the following technical effects:

Through the vertical adaptation structure of the horizontal guide rail assembly 310 and the vertical guide rail assembly 320 in the positioning assembly 300, as well as the sliding fit design between the first engagement protrusion 3111 and the first engagement groove 141, and the second engagement protrusion 3211 and the second engagement groove 3121, the existing platform's lack of precise guidance and limitation to single-direction displacement is resolved, while also avoiding jamming issues caused by rigid contact. This enables the platform body 100 and the drive assembly 400 to move smoothly along the horizontal two-dimensional plane, significantly improving the positioning accuracy of milling locations. The coordinated structure of the height adjusting screw 103 and the six symmetrical optical shafts 106 in the platform body 100 allows flexible adaptation to the milling height requirements of wood boards of varying thicknesses through the adjusting screw 103's threaded transmission, while the linear guidance of the optical shafts 106 restricts tilting deflection of the base plate 102, ensuring lifting stability. Simultaneously, the multi-group concentric through holes 1211 layout of the connection assembly 120 enhances compatibility with drive assemblies 400 of different specifications. The collaborative suction structure of the dust suction pipe 210 and the dust suction chamber 132 in the pipeline 130 of the dust collection assembly 200, combined with the enclosed layout of the protective curtain 107 along the edge of the base plate 102, enables comprehensive cleaning of milling debris through negative pressure suction while reducing dust dispersion and preventing debris accumulation from affecting equipment operation. The columnar vertical fixation structure of the handle assembly 150 on both sides of the platform body 100 allows operators to conveniently grip and push the platform along the guide rails, reducing the operational difficulty of position adjustments and enabling efficient regulation of the drive assembly 400's working position. These features collectively enhance the precision, efficiency, and practicality of wood board milling operations across a plurality of dimensions.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. An auxiliary platform for a wood board milling machine, comprising:
a platform body configured to carry a drive assembly; and
a positioning assembly supporting the platform body, comprising:
a horizontal guide rail assembly, comprising at least one first rail extending along a first horizontal direction; and
a vertical guide rail assembly, comprising at least one second rail extending along a second horizontal direction, wherein the second horizontal direction is perpendicular to the first horizontal direction;
wherein the platform body is slidably connected to the first rail through a first guiding structure, and the horizontal guide rail assembly is slidably connected to the second rail through a second guiding structure; and
both the first guiding structure and the second guiding structure comprise an engagement protrusion and an engagement groove that are mutually engaged, and the engagement protrusion is embedded in the engagement groove to form sliding fit for restricting displacement of connected components in directions perpendicular to movement while providing sliding guidance.

2. The auxiliary platform for a wood board milling machine according to claim 1, wherein the platform body comprises a connection frame and a base plate; and
the platform body further comprises handle assemblies vertically fixed to both sides of the connection frame.

3. The auxiliary platform for a wood board milling machine according to claim 2, wherein the base plate comprises a connection assembly, and the connection assembly comprises a fixing plate and a fastener; and
the drive assembly is fixed to the platform body through the connection assembly.

4. The auxiliary platform for a wood board milling machine according to claim 3, wherein a surface of the fixing plate is provided with a plurality of sets of through holes arranged in a plurality of concentric circles along a radial direction of the fixing plate, for adapting to installation of drive assemblies of different sizes.

5. The auxiliary platform for a wood board milling machine according to claim 1, further comprising a drive assembly, wherein the drive assembly comprises a drive motor and a milling blade, and the milling blade of the drive assembly is a removable carbide blade.

6. The auxiliary platform for a wood board milling machine according to claim 1, wherein the horizontal guide rail assembly comprises two parallel first rails, and the vertical guide rail assembly comprises two parallel second rails that are perpendicular to the first rails.

7. An auxiliary platform for a wood board milling machine, comprising:
a platform body configured to carry a drive assembly, the platform body comprising an internally hollow pipeline, the pipeline comprising at least one set of connecting holes; and
a dust collection assembly, comprising at least one dust suction pipe, one end of the dust suction pipe being connected to the connecting holes of the pipeline, and the other end being configured to connect to an external negative pressure generator; and
a positioning assembly supporting the platform body, comprising:
a horizontal guide rail assembly, comprising at least one first rail extending along a first horizontal direction; and
a vertical guide rail assembly, comprising at least one second rail extending along a second horizontal direction, wherein the second horizontal direction is perpendicular to the first horizontal direction;
wherein the platform body is slidably connected to the first rail through a first guiding structure, and the horizontal guide rail assembly is slidably connected to the second rail through a second guiding structure; and
both the first guiding structure and the second guiding structure comprise an engagement protrusion and an engagement groove that are mutually engaged, and the engagement protrusion is embedded in the engagement groove to form sliding fit for restricting displacement of connected components in a direction perpendicular to a movement diretion while providing sliding guidance.

8. The auxiliary platform for a wood board milling machine according to claim 7, wherein the pipeline is configured as an arc-shaped hollow protrusion structure, with one end internally forming a dust suction chamber connected to a bottom surface of the platform body.

9. The auxiliary platform for a wood board milling machine according to claim 8, wherein there are two dust suction pipes, with one end of each of the two pipes converging into a single opening to connect to the external negative pressure generator.

10. The auxiliary platform for a wood board milling machine according to claim 7, wherein the external negative pressure generator is any one of a dust collector, a vacuum pump, or equivalent devices thereof.

11. The auxiliary platform for a wood board milling machine according to claim 7, wherein the pipeline is provided with three sets of connecting holes, and the dust suction pipe is fixedly connected to any one set of the connecting holes.

12. The auxiliary platform for a wood board milling machine according to claim 7, wherein the platform body comprises a connection frame and a base plate; and
the platform body further comprises a protective curtain, and the protective curtain consists of a plurality of elastic-deformable plate-shaped components distributed along an edge of the base plate of the platform body.

13. An auxiliary platform for a wood board milling machine, comprising:
a platform body configured to carry a drive assembly, the platform body comprising a connection frame and a base plate arranged below the connection frame; and
a height adjustment mechanism integrated into the platform body for adjusting a height of the base plate relative to the connection frame, thereby regulating a milling height of the drive assembly, wherein the height adjustment mechanism comprises:
an adjusting screw, with the connection frame penetrating therethrough, and a bottom end in running fit the base plate;
a locking key sleeved onto the adjusting screw for locking or releasing the adjusting screw; and
a positioning assembly supporting the platform body, comprising:
a horizontal guide rail assembly, comprising at least one first rail extending along a first horizontal direction; and
a vertical guide rail assembly, comprising at least one second rail extending along a second horizontal direction, wherein the second horizontal direction is perpendicular to the first horizontal direction;
wherein the platform body is slidably connected to the first rail through a first guiding structure, and the horizontal guide rail assembly is slidably connected to the second rail through a second guiding structure; and
both the first and second guiding structures comprise an engagement protrusion and an engagement groove that are mutually engaged, and the engagement protrusion is embedded in the engagement groove to form sliding fit for restricting displacement of connected components in a direction perpendicular to a movement direction while providing sliding guidance.

14. The auxiliary platform for a wood board milling machine according to claim 13, wherein a top end of the adjusting screw is equipped with an adjusting knob, and the adjusting knob is manually rotated to drive the base plate to move axially along the adjusting screw for height adjustment.

15. The auxiliary platform for a wood board milling machine according to claim 13, wherein the platform body comprises at least one optical shaft between the connection frame and the base plate, with both ends of the optical shaft fixed to the connection frame and the base plate respectively, limiting the base plate to vertical translation and preventing tilting of the base plate.

16. The auxiliary platform for a wood board milling machine according to claim 15, wherein six optical shafts are symmetrically arranged to evenly distribute load and enhance lifting stability.

17. The auxiliary platform for a wood board milling machine according to claim 13, wherein the platform body further comprises handle assemblies vertically fixed on both sides of the connection frame.

18. The auxiliary platform for a wood board milling machine according to claim 13, wherein the base plate comprises a connection assembly, and the connection assembly comprises a fixing plate and a fastener; and
the drive assembly is fixed to the platform body through the connection assembly.

19. The auxiliary platform for a wood board milling machine according to claim 18, wherein a surface of the fixing plate surface is provided with a plurality of sets of through holes arranged in a plurality of concentric circles along a radial direction of the fixing plate, for adapting to installation of drive assemblies of different sizes.

20. The auxiliary platform for a wood board milling machine according to claim 13, wherein the horizontal guide rail assembly comprises two parallel first rails, and the vertical guide rail assembly comprises two parallel second rails that are perpendicular to the first rails.
